(19) United States
(12) Patent Application Publication
(10) Pub. No.: US 2010/0052940 A1
(43) Pub. Date: Mar. 4, 2010

(54) POWER LINE COMMUNICATION DEVICE FOR SUBSEA WELL

(75) Inventors: Sigbjorn Hesbol, Oslo (NO); Vegard Horten, Rasta (NO); Vidar Steigen, Nittedal (NO)

Correspondence Address: King & Spalding LLP, 401 Congress Avenue, Suite 3200, Austin, TX, 78701, US

(73) Assignee: Siemens Aktiengesellschaft

(21) Appl. No.: 12/374,711

(22) PCT Filed: Jul. 24, 2006
(86) PCT No.: PCT/EP2006/007270

§ 371 Date: Oct. 16, 2009

(51) Int. Cl. H04B 13/02; H04L 27/28

(52) U.S. Cl. 340/850; 375/260

(57) ABSTRACT

An electronic subsea device (1), in particular a wellhead control unit, has a modem (2) for subsea power line (3) communication, and an alternating current/direct current power supply (33) that is a switching power supply having a fixed switching frequency of more than 400 kHz.

### CROSS-REFERENCE TO RELATED APPLICATIONS

This application is a U.S. National Stage Application of International Application No. PCT/EP2006/007270 filed Jul. 24, 2006, which designates the United States of America. The contents of which are hereby incorporated by reference in their entirety.

### TECHNICAL FIELD

The invention relates to an electronic subsea device, in particular a wellhead control unit, comprising a modem for subsea power line communication, and an alternating current/direct current (AC/DC) power supply.

### BACKGROUND

Subsea power line communication is a special form of underwater communication. It is preferably used in exploring and exploiting gas and oil fields located at the seabed. Subsea communication is used, for example, for transmitting binary data between topside control sites and subsea wellheads. Gas and oil fields that are explored or exploited using electronic communication to the wellheads or to other electronic equipment are sometimes called “electronic fields” (e-fields).

In prior art, different techniques for subsea communication have been described. On the one hand, there are wired electric or optical connections, on the other hand there are wireless connections. The wired connections can be subdivided into a first group providing communication lines for electronic or optical connections separate from electric power lines, and a second group utilizing power lines for electronic communications. In the latter case, advantageously no separate communication lines are needed.

For example, in US 2005/0243983 A1, a modem for receiving and transmitting data from and to a conductor is described. It comprises an output drive for transmitting data to the conductor, a receiver for receiving data from the conductor and impedance matching means for matching an impedance of a receiver input with an impedance of the conductor. A gain of the output drive, a receiver gain and the impedance of the receiver input are adjustable at this modem.

Known wellhead control units comprising a power line modem suffer from electronic noise and interference, in particular introduced into the power line by external topside sources and by power supplies. These effects significantly limit transmission bit rates and operational ranges of the modem.

Conventional wellhead control units comprise a switching power supply having fixed a switching frequency of typically 75 kHz or 100 kHz. They comprise a modem that uses frequency shift keying modulation technique at signal frequencies above 100 kHz for power line communication. For this purpose, the known modems make use of diplexers comprising a low-pass filter for the electric signal and a high pass filter for the modulated binary data, filtering out frequencies above and below 100 kHz, respectively. As a consequence, the power supply switching frequency and/or its harmonics interfere with the communication signals, e.g. by creating noise.

### SUMMARY

According to various embodiments, an electronic subsea device can be specified by which communication is possible at significantly higher bit rates and larger operational ranges by reducing electronic noise and interference in the power line.

According to an embodiment, an electronic subsea device may comprise a modem for subsea power line communication, and an alternating current/direct current power supply, wherein the alternating current/direct current power supply is a switching power supply having a fixed switching frequency of more than 400 kHz.

According to a further embodiment, the fixed switching frequency can be 500 kHz. According to a further embodiment, the alternating current/direct current power supply may comprise a filter for preventing frequencies of a frequency range within an interval of 2 kHz to 400 kHz from reaching the power line. According to a further embodiment, the electronic subsea device may comprise two redundant power supply paths connected in parallel and separated by redundancy diodes. According to a further embodiment, the alternating current/direct current power supply may be designed for a direct current/direct current power supply load. According to a further embodiment, the direct current/direct current power supply may have a fixed switching frequency of 75 kHz or 100 kHz. According to a further embodiment, the alternating current/direct current power supply may be in thermal contact with a metal structure of the electronic subsea device via a shim unit. According to a further embodiment, the modem may use orthogonal frequency division multiplexing for modulating binary data onto an electric signal of the power line. According to a further embodiment, the modem may use a frequency range within an interval from 2 kHz to 400 kHz for the radio frequency signal. According to a further embodiment, the electronic subsea device may comprise a diplexer that comprises a low-pass filter for the electric signal and a band-pass filter for a radio frequency signal comprising the modulated binary data.

### BRIEF DESCRIPTION OF THE DRAWINGS

In the following, the invention is described in further detail with several drawings.

FIG. 1 shows a block diagram of a subsea power line modem.

FIG. 2 shows a block diagram of the power supply of the modem.

FIG. 3 shows a block diagram of the diplexer of the modem.

FIG. 4 schematically shows the power supply in a side view.

FIG. 5 shows an efficiency diagram of the modem.

In all drawings, corresponding parts are denoted by identical reference signs.

### DETAILED DESCRIPTION

According to various embodiments, a switching power supply can be used having a fixed switching frequency of more than 400 kHz, in particular of 500 kHz. By this solution, i. e., using a high switching frequency, the power line communication can be performed using modulation frequencies below 400 kHz without interference from the power supply. The harmonics frequencies are higher than the switching frequency, thus causing no interference and noise problems for the communication frequencies either.

In an embodiment, said power supply comprises a filter circuitry for preventing signals of a frequency range within an interval of 2 kHz to 400 kHz from reaching said power line. This way it is possible to securely prevent electronic noise in the communication frequency range, created by the power supply itself or by downstream electronic components, from reaching back onto the subsea power line and disturbing the power line communication. Hence, jamming of the power line carrier frequencies between 2 kHz and 400 kHz is avoided.

Advantageously, the electronic subsea device may comprise two redundant power supply paths connected in parallel and separated by redundancy diodes. Preferably, both power supply paths can be constructed identically. This ensures stable operation of the modem even if one power supply path is rendered out of service. The redundancy diodes prevent a short circuit and hence a complete failure of the electronic subsea device in this case.

Preferably, the power supply, comprising in particular both power supply paths, may be designed for a direct current/direct current power supply load, which in particular has a fixed switching frequency of 75 kHz, 100 kHz or a different value. This enables stable operation of the modem and allows for reusing conventional circuitry designs based on a 75 kHz or 100 kHz switching frequency or other fixed frequencies in the electronic subsea device.

In another embodiment, said power supply is in thermal contact with metal structures of the modem via a shim unit. This allows for dissipating heat from the power supply unit to the metal structures, for example, in the main electronic rack of the subsea device.

For high bit rates and long operational ranges, said modem preferably uses orthogonal frequency division multiplexing (OFDM) for modulating binary data onto an electric signal of said power line. According to various embodiments, the orthogonal frequency division multiplexing is preferably performed in both of two communicating modems, one at the seabed and one at the topside. This way, a point-to-point connection at a high bit rate of up to 3 Mbit/s can be provided, for example, between a subsea electronic device and a topside control site.

With orthogonal frequency division multiplexing, which itself is known from television broadcasting, the transmitting modem sends on multiple different orthogonal frequencies called carrier bands or channels. Two carrier bands are said to be orthogonal if they are independent from each other regarding their relative phase relationship. The binary data is modulated onto the electric signal in the form of so-called orthogonal frequency division multiplexing symbols.

Using orthogonal frequency division multiplexing for subsea power line communication results in several advantages. The different carrier bands can be close to each other in terms of frequency, thus enabling high spectrum efficiency, allowing for a high total bit rate. Besides, orthogonal frequency division multiplexing allows for additionally filtering out noise. If a certain frequency range encounters interference, the respective carrier bands can be operated a slower bit rate or can even be disabled. This way, a high operational range up to 200 km can be achieved. Additionally, by assigning appropriate numbers of carrier bands to upstream and downstream transmission, the respective bit rates can be adjusted as required.

In other embodiments a frequency range within an interval from 2 kHz to 400 kHz is used for orthogonal frequency division multiplexing, i. e., said modulated binary data. It is possible to use a frequency range having the same width as this interval or narrower than this interval, e. g. 10 kHz to 400 kHz. This embodiment provides a wide frequency band for orthogonal frequency division multiplexing, hence enabling a larger number of carrier bands and thus high bit rates. In combination with the power supply according to various embodiments, an optimal orthogonal frequency division multiplexing signal transmission can be achieved. This is in particular achieved by using frequencies below 100 kHz, in contrast to prior art. Thus, broadband transmission is possible, resulting in higher bit rates. The upper limit of 400 kHz reduces high-frequency noise caused by switching power supplies, and their harmonics, as well as noise picked up from topside sources. Besides, the attenuation of subsea cables is high in frequencies above 400 kHz.

Advantageously, the electric signal may be passed through a lowpass filter, and the modulated binary data is passed through a band-pass filter. The filters are preferably comprised in a diplexer unit of the modem. The band-pass filter allows passing through frequencies from 2 kHz to 400 kHz for a best achievable signal. The low-pass filter allows cutting out the disturbance from the low frequency noise from topside and subsea power supplies and other sources before the modem signal is superimposed on the subsea power line. Preferably, the low-pass filter starts to bend from 2 kHz and down to 0 Hz.

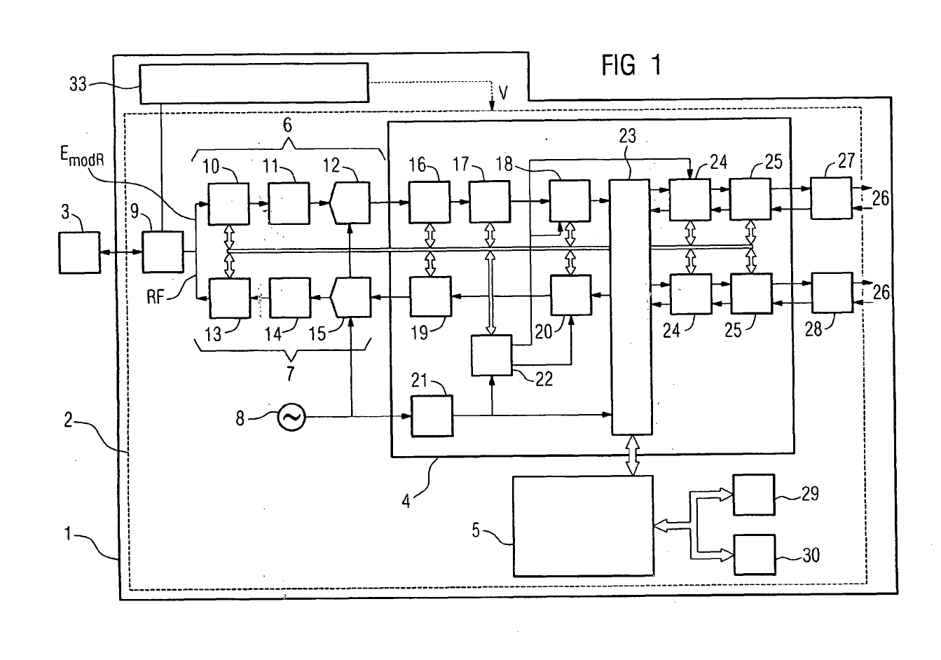

FIG. 1 shows a block diagram of an exemplary electronic subsea device 1, being a wellhead control unit. It comprises a modem 2 for communication via a subsea power line 3 to an efield (not shown). The power line 3 is also called the umbilical. The modem 2 comprises a field programmable gate array 4, a digital signal processor 5, an analogue-to-digital processing line 6 and a digital-to-analogue processing line 7, clocked by a 2 MHz oscillator 8. Both processing lines 6 and 7 are connected with a diplexer 9 via a differential interface (not shown). By the diplexer 9, the modem 2 is connectable to the subsea power line 3.

The analogue-to-digital processing line 6 comprises a low-noise amplifier 10, an anti-aliasing filter 11 and an analogue-to-digital converter 12. The digital-to-analogue processing line 7 comprises a power amplifier 13, a low-pass filter 14 and a digital-to-analogue converter 15. The processing lines 6, 7 are continued in the field programmable gate array 4 by a high-pass filter 16, a receive filter and decimator 17 and a receive first-in-first-out buffer 18 (FIFO), as well as a send filter and interpolator 19 and a send first-in-first-out buffer 20. The field programmable gate array 4 furthermore comprises a clock phase locked loop 21, an orthogonal frequency division multiplexing timing unit 22, a digital signal processor interface 23 comprising programming registers (not shown), two in and out first-in-first-out buffers 24, and two universal asynchronous receiver transmitters 25 (UART). The field programmable gate array 4 provides two independent bidirectional external serial interfaces to external electronic units 26, one RS-485 connection 27 connectable with a so-called PROFIBUS for binary payload data, and one RS-232 connection 28 for diagnostic data. The components are mounted on both sides of a single six-layer printed circuit board (PCB; not shown in this figure).

The modem 2 uses orthogonal frequency division multiplexing for modulating and demodulating binary payload data to and from the electric signal of the power line 3. The orthogonal frequency division multiplexing is essentially performed by the field programmable gate array 4. On the one hand, it creates an orthogonal frequency division multiplexing modulated signal RF from the binary data obtained from the RS-485 connection 27 and, if required, from diagnostic data obtained from the RS-232 connection 28. These data are modulated as the orthogonal frequency division multiplexing modulated signal RF onto the electric signal E_{modRF} of the power line 3. On the other hand, the field programmable gate array 4 demodulates an orthogonal frequency division multiplexing modulated signal E_{modRF} obtained from the power line 3 via the diplexer 9 into binary payload data, and, if necessary, into diagnostic data that are output to the RS-485 connection 27 and the RS-232 connection 28, respectively.

As computation costs are high for orthogonal frequency division multiplexing, the field programmable gate array 4 utilizes the digital signal processor 5 for both modulation and demodulation. Appropriate digital signal processors 5 with a program flash 29 and a data memory 30 are commercially available. The digital signal processor 5 is connected via the digital signal processor interface 23 with the field programmable gate array 4. The digital signal processor interface 23 is synchronized with 48 MHz by the clock phase-locked loop 21 with a reference frequency, e.g. 2 MHz, of the voltage controlled oscillator 8.

The modem 2 is provided with energy by an alternating current/direct current power supply 33 that is connected to the diplexer 9 on its input side.

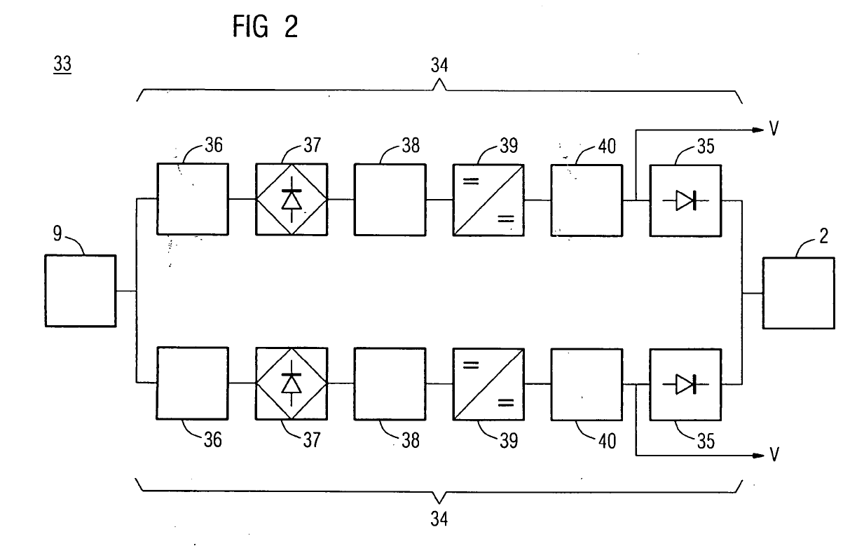

The alternating current/direct current power supply 33 is shown in FIG. 2 as a block diagram. The alternating current/direct current power supply 33 is a unit with universal alternating current input and a 24 V/100 W direct current output. It is designed for redundant operation as two power supply paths 34 are connected together separated with redundancy diodes 35. Each power supply path 34 is connected to the diplexer 9 on its input side. Each power supply path 34 comprises a filter and over-voltage protection unit 36, a rectifying bridge 37, a hold capacitor 38, a direct current/direct current (DC/DC) converter 39, an output filter 40 and the respective redundancy diode 35. Both direct current/direct current converters 39, for example, of type DAS100F24, have a fixed switching frequency of 500 kHz. This way, both the switching frequency and its harmonics are outside all carrier frequencies that the modem 2 utilizes on the power line 3. The presence of the voltages in the power supply paths 34 can be detected at a contact V directly before the respective redundancy diode 35.

The alternating current/direct current power supply 33 is designed to stand a direct current/direct current power supply load having a switching frequency of fixed 75 kHz and fixed 100 kHz. The alternating current/direct current power supply 33 is designed to limit frequencies from 2-400 kHz from being fed back onto the power line 3 by the filter and over-voltage protection unit 36. Input cables 41 and output cables 42 are physically kept away from each other, and twisted pairs are used for both input and output cables 41, 42. Thus, electronic interference and noise from the switching alternating current/direct current power supply 33 are minimized on the power line 3. Optimal quality of subsea power line communication is ensured this way.

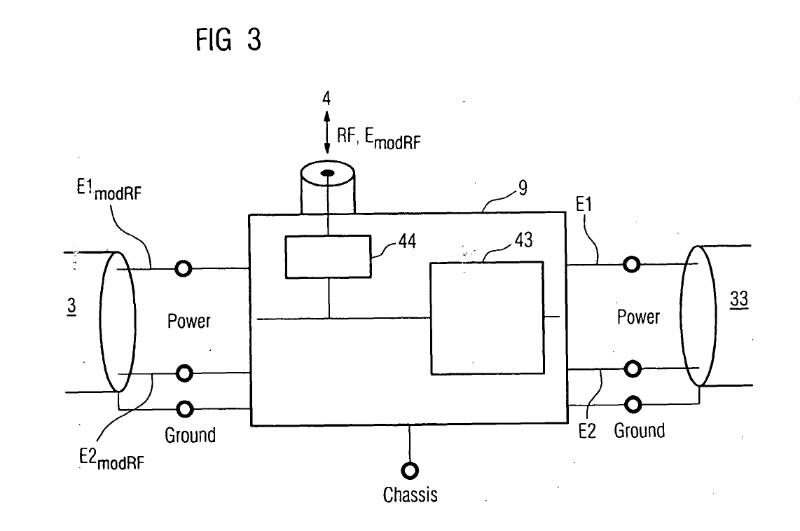

FIG. 3 shows a block diagram of the diplexer 9, comprising a low-pass filter 43 for the electric signal E1, E2 and a bandpass filter 44 for the modulated binary data. The diplexer 9 is uniform for both subsea and topside modems 2.

In case of a topside diplexer 9, a topside power supply 46 of an electronic topside device (not shown) with electric power signals E1 and E2 is connected at the right end of the block diagram. The radio frequency signal RF, i. e. the modulated binary data, is input from the field programmable gate array 4, with the so-called orthogonal frequency division multiplexing circuits 4 to 7. The orthogonal frequency division multiplexing modulated electric power signals E1_{modRF}, E2_{modRF} are then conducted towards subsea power line 3 on the left side of the block diagram.

A diplexer 9 for subsea use receives the orthogonal frequency division multiplexing modulated electric power signal EmodRF at the left side of the block diagram. The radio frequency signal RF, representing the modulated binary data, is extracted by the band-pass filter 44 that is connected to the orthogonal frequency division multiplexing circuits 13 to 15 of the modem 2. The subsea power supply 33 is connected at the right side of the block diagram.

The low-pass filter 43 filters noise from the power supplies 33/46 from being fed to the communication part of the subsea power line 3. The band-pass filter 44 allows for frequencies from 10 kHz to 400 kHz to be passed through.

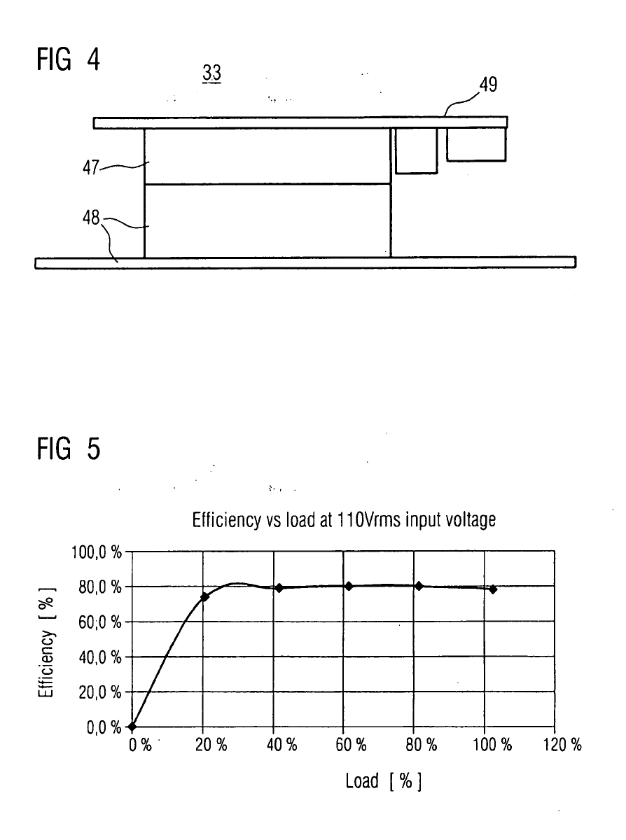

In FIG. 4, a schematic side view of the subsea alternating current/direct current power supply 33 is depicted. It is mounted on a shim unit 47. The shim unit 47 is a solid aluminium unit screwed onto the alternating current/direct current power supply 33 unit. It gives heat dissipation from the alternating current/direct current power supply 33 unit to metal structures 48 in the main electronic rack (not shown).

The shim unit 47 causes the alternating current/direct current power supply 33 to be mounted with the. Printed Circuit Board 49 upside-down. All components are glued, strapped or screwed for optimal fastening purposes.

FIG. 5 shows an efficiency curve obtained from prototype alternating current/direct current power supplies 33 that have been tested for numerous load set-ups to measure and calculate the power efficiency. It can be seen that efficiency is satisfying already at 20% load with low input voltage, in this case 110 V. This is advantageous for subsea use, because the power drops proportionally with the length of the power line 3. One Subsea Electronic Module (SEM) such as the modem 2 optimally is totally a 24 W load. This means that this AC/alternating current/direct current power supply 33 rated 100 W is giving 80% efficiency at a load of 25%. This is beneficial for the power supply stability and it minimizes the alternating current/direct current power supply 33 waste heat.

What is claimed is:

1. Electronic subsea device comprising a modem for subsea power line communication, and an alternating current/direct current power supply, wherein said alternating current/direct current power supply is a switching power supply having a fixed switching frequency of more than 400 kHz.

2. The electronic subsea device according to claim 1, wherein the fixed switching frequency is 500 kHz.

3. The electronic subsea device according to claim 1, wherein said alternating current/direct current power supply comprises a filter for preventing frequencies of a frequency range within an interval of 2 kHz to 400 kHz from reaching the power line.

4. The electronic subsea device according to claim 1, comprising two redundant power supply paths connected in parallel and separated by redundancy diodes.

5. The electronic subsea device according to claim 1, wherein said alternating current/direct current power supply is designed for a direct current/direct current power supply load.

6. The electronic subsea device according to claim 5, wherein said direct current/direct current power supply has a fixed switching frequency of 75 kHz or 100 kHz.

7. The electronic subsea device according to claim 1, wherein said alternating current/direct current power supply is in thermal contact with a metal structure of the electronic subsea device via a shim unit.

8. The electronic subsea device according to claim 1, wherein said modem uses orthogonal frequency division multiplexing for modulating binary data onto an electric signal of the power line.

9. The electronic subsea device according to claim 8, wherein said modem uses a frequency range within an interval from 2 kHz to 400 kHz for said radio frequency signal.

10. The electronic subsea device according to claim 8, comprising a diplexer that comprises a low-pass filter for said electric signal and a band-pass filter for a radio frequency signal comprising said modulated binary data.

11. The electronic subsea device according to claim 1, wherein the electronic subsea device is a wellhead control unit.

12. A method for operating an electronic subsea device comprising a modem for subsea power line communication, and an alternating current/direct current power supply, wherein said alternating current/direct current power supply is a switching power supply, the method comprising the step of operating said switching power supply with a fixed switching frequency of more than 400 kHz.

13. The method according to claim 12, wherein the fixed switching frequency is 500 kHz.

14. The method according to claim 12, wherein said alternating current/direct current power supply comprises a filter for preventing frequencies of a frequency range within an interval of 2 kHz to 400 kHz from reaching the power line.

15. The method according to claim 12, comprising the step of providing two redundant power supply paths connected in parallel and separated by redundancy diodes.

16. The method according to claim 12, wherein said alternating current/direct current power supply is designed for a direct current/direct current power supply load and operating said direct current/direct current power supply with a fixed switching frequency of 75 kHz or 100 kHz.

17. The method according to claim 12, comprising arranging said alternating current/direct current power supply in thermal contact with a metal structure of the electronic subsea device via a shim unit.

18. The method according to claim 12, further comprising using orthogonal frequency division multiplexing by said modem for modulating binary data onto an electric signal of the power line.

19. The method according to claim 12, wherein said modem uses a frequency range within an interval from 2 kHz to 400 kHz for said radio frequency signal.

20. The method according to claim 18, comprising the step of providing a diplexer that comprises a low-pass filter for said electric signal and a band-pass filter for a radio frequency signal comprising said modulated binary data.
